(19) United States
(12) Patent Application Publication
(10) Pub. No.: US 2008/0189182 A1
(43) Pub. Date: Aug. 7, 2008

(54) Method for repairing, maintaining and replacing selected equipment

(76) Inventor: David B. Price, Manhattan, IL (US)

Correspondence Address: DONALD G. FLAYNIK, JR;CHERSKOV & FLAYNIK, P.O. BOX 114, 25208 WEST ROAD ST., CHANNAHON, IL, 60410, US

(21) Appl. No.: 12/069,141

(22) Filed: Feb. 7, 2008

Related U.S. Application Data
(60) Provisional application No. 60/900,087, filed on Feb. 7, 2007.

(51) Int. Cl. G06Q 99/00

(52) U.S. Cl. 705/14; 705/1

(57) ABSTRACT

A method 10 for repairing, maintaining and replacing selected equipment includes selecting equipment for repair, maintenance and replacement services 12, selecting a first entity for warranting repair services for the selected equipment 14, selecting a second entity for holding funds for maintaining and replacing the selected equipment 16, selecting a third entity for maintaining and replacing the selected equipment 17, contacting an owner of the selected equipment for entering into a service agreement for the selected equipment 18, verifying that the owner and the selected equipment satisfy conditions in the service agreement 20, providing a maintenance and replacement services contract for signing by the owner and third entity 24, verifying acceptance of the maintenance and replacement services contract 26, and submitting the maintenance and replacement services contract for approval by a user of the method 28.

This application is based on U.S. Provisional Application No. 60/900,087, filed on Feb. 7, 2007.

### BACKGROUND OF THE INVENTION

1. Field of the Invention

This invention relates to repairing, maintaining and replacing selected equipment, and more particularly, to a method that allows a user of the method to make money while enabling an owner of the selected equipment to make predetermined installment payments to achieve the repair, maintenance and replacement of the selected equipment, which ordinarily requires the unplanned payment of relatively large sums of money.

2. Background of the Prior Art

Mechanical and electrical equipment used in a home or required to operate a business needs repairs, maintenance and replacement over time. The problem is that it is difficult for an owner of the equipment to foresee when the equipment will require repair, maintenance and replacement work; and more importantly, what amount of money to budget for the future events. Although the owner of the home or business may not care about all the equipment in the premises, the owner will have concerns about the more important or select equipment that the owner must have for home comfort or for business operation.

Prior art methods for protecting against selected equipment failure is to purchase warranties for the selected equipment via expensive, up-front, one time payments. The warranties only provide for the repair of the selected equipment, and do not consider the maintenance and replacement requirements of the selected equipment. Further, the warranties generally do not allow the owner to approve a repair contractor, the provider of the warranty selects the contractor. Also, the owner generally does not have the experience to select the best warranty or to approve an experienced contractor to repair, maintain and replace the selected equipment.

A need exists for a method that enables a user (preferably an entity or individual having experience with the selected equipment) of the method to provide an owner of a home or business, the option of making predetermined payments over a preselected time period for the repair, maintenance and replacement of selected equipment. A need further exists for a method that enables a user of the method to select qualified entities to hold funds paid by the owner of the selected equipment, and to pay funds to predetermined entities, including qualified contractors, to cause the repair, maintenance and replacement of the selected equipment.

### SUMMARY OF THE INVENTION

It is an object of the present invention to overcome many of the disadvantages associated with repairing, maintaining and replacing selected equipment, including but not limited to heating, ventilating and air conditioning equipment, electrical and/or mechanical equipment.

A principal object of the present invention is to provide a method for repairing selected equipment. A feature of the method is the selection of a first entity by the user of the method, the first entity ultimately providing limited warranty contracts to an owner of selected equipment for the repair of the selected equipment. Another feature of the method is the selection of a second entity by the user of the method, the second entity ultimately financing the warranties provided by the first entity. Another feature of the method is the selection of a third entity or contractor by agreement between the user of the method and the first entity, the contractor ultimately providing repair services for the selected equipment of the owner. An advantage of the method is that the first entity gets paid “up-front” from the second entity to issue the warranty contract to the owner for the repair of the selected equipment for a predetermined time period. Another advantage of the method is that the user of the method receives a commission from the first entity after the first entity is paid by the second entity for issuing the warranty contract to the owner. Another advantage of the method is that the owner pays for the warranty for the selected equipment via installment payments over a predetermined time period. Still another advantage of the method is that the user of the method and the first entity verify that the contractor is ready, willing and able to provide the required repair services.

Another object of the present invention is to provide a method for maintaining and replacing selected equipment. A feature of the method is the using of the third entity (contractor) selected by the first entity and the user of the method to perform repair services, to maintain and ultimately replace the selected equipment of the owner. Another feature of the method is the contacting of an owner of the selected equipment to entice the owner to enter into a contract with the third entity for the maintenance and replacement of the owner's selected equipment, the owner ultimately receiving the warranty from the first entity for the repair of the selected equipment, after the owner and the third entity sign the maintenance and replacement contract, and after the user approves the contract. Yet another feature of the method is the owner paying predetermined monthly installment payments to the second entity, after all signatures are on the maintenance and replacement contract. Still another feature of the method is the holding of the owner's monthly installment payments by the second entity in a dedicated reserve fund, the reserve fund ultimately paying for the maintenance and replacement of the selected equipment of the owner. An advantage of the method is that the selected third entity to maintain and replace the owner's selected equipment, will be ready, willing and able to provide services for the selected equipment in a workmanlike manner. Another advantage of the method is that the contract between the owner and third entity may include only provisions that are acceptable to the user and that do not place the user of the method at a disadvantage. Another advantage of the method is that the user of the method receives all interest earned on the balance in the reserve fund held by the second entity. Another advantage of the method is that the owner is allowed to budget for future the repair, maintenance and replacement of the selected equipment. Another advantage of the method is that the owner of the selected equipment is allowed to replace older equipment in a timely manner with energy efficient equipment. Yet another advantage of the method is that the second entity is paid a predetermined monthly fee for each reserve fund held by the second entity. Yet another advantage of the method is that the second entity is able to use a predetermined percentage of the money in each reserve fund for lending to qualified debtors.

Another object of the present invention is to allow the user of the method to direct the first entity to issue warranties to owners, and to allow the user to direct the second entity to pay funds to the first entity and the third entity. A feature of the method is the execution of contracts between the user of the method and the first entity, and the user and the second entity. An advantage of the method is that the user of the method controls the entities involved with the method. Another advantage of the method is that the user includes in said contracts, promises from the first and second entities that they will not compete against the user by utilizing said method to their advantage and to the user's disadvantage.

Another object of the present invention is to provide a method for repairing, maintaining and replacing selected equipment. A feature of the method is the providing of a repair warranty to an owner of selected equipment. Another feature of the method is the providing of maintenance and replacement obligations to said owner of the selected equipment. Yet another feature of the method is the interrelation between a user of the method and entities providing services pertaining to the repair and/or pertaining to the maintenance and replacement of selected equipment of an owner. An advantage of the method is that money is always available to pay a third entity (contractor) for the repair, maintenance and replacement of the owner's selected equipment. Yet another advantage of the method is that the owner's selected equipment is maintained or replaced as required, irrespective of the financial condition of the owner so long as the owner makes predetermined monthly payments to a second entity (finance company).

Briefly, the invention provides a method for repairing, maintaining and replacing selected equipment, said method comprising the steps of:

selecting equipment for repair, maintenance and replacement services;

selecting a first entity for providing a repair service agreement to an owner of said selected equipment, said repair service agreement requiring said first entity to cause the repair of said selected equipment for a predetermined time period;

selecting a second entity for prepaying said repair service agreement and for holding funds paid by said owner to maintain and replace said selected equipment;

selecting a third entity for repairing, maintaining and replacing said selected equipment, said first entity and the user of said method for repairing, maintaining and replacing selected equipment must agree to the selection of said third entity;

contacting an owner of said selected equipment, said repair service agreement ultimately binding said first entity to repair said selected equipment of said owner;

verifying that said owner and said selected equipment satisfy preestablished requirements;

providing a maintenance and replacement services contract that binds said third entity and said owner of said selected equipment after a user of said method authorizes said contract, said maintenance and replacement contract requiring said owner of said selected equipment to make predetermined payments to said second entity for a predetermined time period, said maintenance and replacement contract requiring said second entity to retain said predetermined payments in a reserve fund for the maintenance and replacement of said selected equipment, said reserve fund being insured by a performance bond, said reserve fund ultimately being used to pay said third entity for maintaining and replacing said selected equipment.

Further, the invention provides a method for an owner of selected equipment to pay for the repair, maintenance and repair of the selected equipment via predetermined installment payments, said method comprising the steps of:

providing a warranty for the repair of the selected equipment for a predetermined time period;

financing the payment of said warranty;

selecting a contractor for repairing the selected equipment pursuant to said warranty;

contacting an owner of the selected equipment;

verifying that the owner and the selected equipment satisfy preestablished conditions; and

binding the owner and said contractor to a maintenance and replacement contract for the selected equipment, said maintenance and replacement contract requiring predetermined installment payments by the owner of the selected equipment into an account earmarked for maintaining and replacing the selected equipment, said maintenance and replacement contract requiring payments to said contractor for maintaining and replacing the selected equipment, said contractor payments being provided by said account earmarked for maintaining and replacing the selected equipment, said maintenance and replacement contract requiring a predetermined portion of said account to be paid to a user of said method.

Also, the invention provides a method for replacing selected equipment via installment payments, said method comprising the steps of:

selecting equipment for repair, maintenance and replacement;

providing a repair warranty to an owner of the selected equipment;

paying the cost of the warranty, a user of said method ultimately receiving a portion of said paid warranty;

repairing the selected equipment when required;

contracting for the maintenance and replacement of the selected equipment, said maintenance and replacement contract being executed by an owner of the selected equipment and a contractor, said contract being authorized by a user of said method; and

paying for the maintenance and replacement of the selected equipment via installment payments from the owner of the selected equipment, said installment payments being held in a reserve account by a finance entity, a predetermined portion of said reserve account being paid to said user of said method, said contractor receiving a predetermined payment from said finance entity after said maintenance and replacement contract is executed by said owner and said contractor and authorized by said user.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIGS. 1 and 2 comprise a flow chart for a method for repairing, maintaining and replacing selected equipment in accordance with the present invention.

### DESCRIPTION OF THE PREFERRED EMBODIMENT

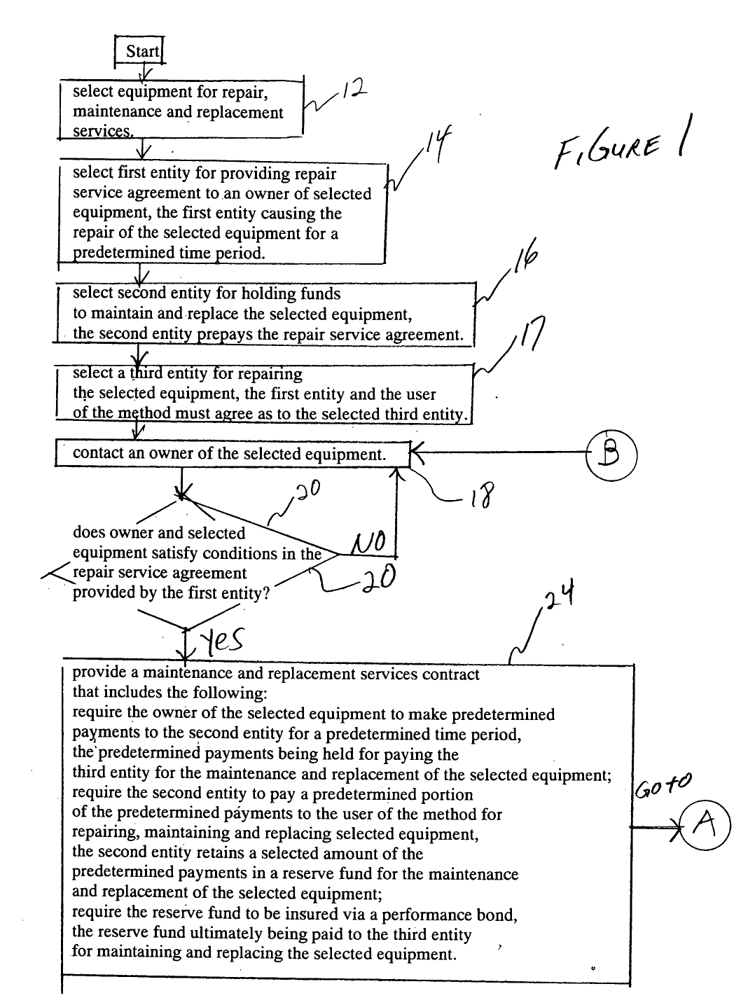

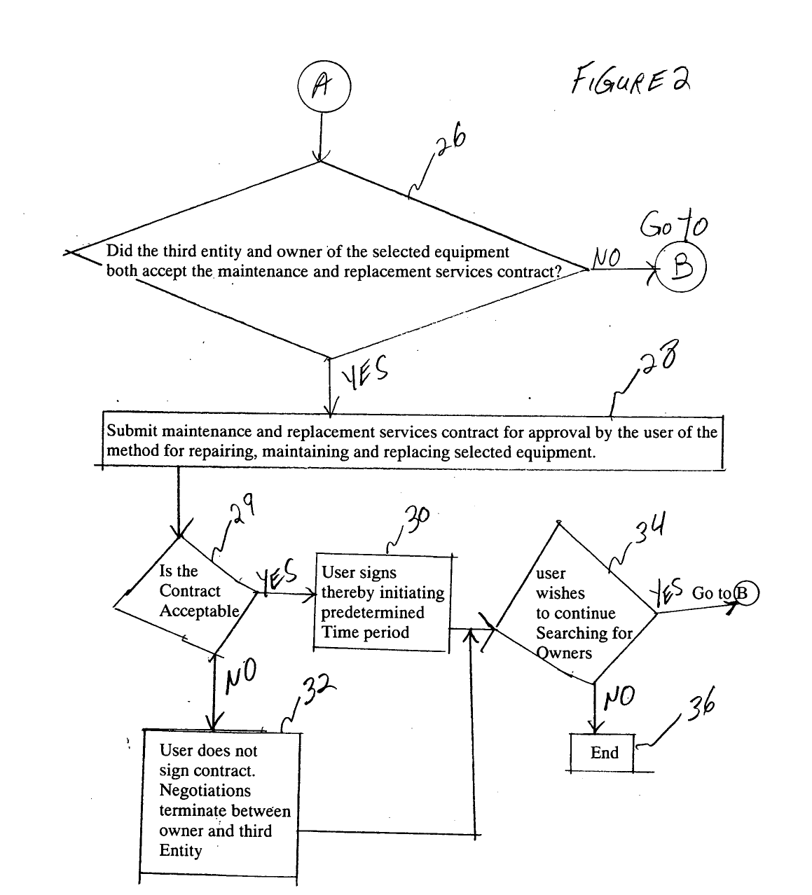

Referring now to FIGS. 1 and 2, a method for repairing, maintaining and replacing selected equipment of any construction, configuration or design, including but not limited to heating, ventilating and air conditioning equipment, electrical and/or mechanical equipment, in accordance with the present invention is denoted as numeral 10. The method includes starting at block 12 where a user of the method 10 selects equipment that will ultimately require repair, maintenance and replacement services. The user may or may not have experience with the selected equipment. If the user has no experience with the selected equipment, then the user will employ entities the do have experience providing services that promote the repair, maintenance and replacement of the selected equipment.

Referring to block 14, after selecting the equipment to be serviced, the user of the method 10 selects and enters into a contract with a first entity (such as Equiguard, Inc., located at 800 Jorie Blvd., Oakbrook, Ill. 60523) that is in the business of providing limited, extended warranties (equipment repair obligations) to owners of the selected equipment. The user of the method promises, among other things, to use only the selected first entity for warranties. The first entity promises to issue warranties to owners pre-qualified by the user of the method. The first entity also promises not to compete against the user of the method. The repair obligation provided by the first entity includes, but is not limited to warranting the continuous operation of heating, ventilating and air conditioning equipment. The first entity ultimately provides a warranty to an owner to repair the selected equipment for a predetermined time period, whereupon, the first entity is paid “up-front” for issuing the warranty by a second entity. The user of the method receives a commission from the first entity via the up-front payment by the second entity. The first entity will be responsible to pay a third entity or contractor to perform physical repair to the selected equipment for a predetermined time period. The first entity and the user of the method must agree as to the contractor selected to repair the selected equipment. The second entity typically prepays the first entity for each warranty at a discounted price that is unavailable to the owner of the selected equipment, should the owner wish to pay the first entity directly for the warranty. The user of the method ultimately procures unsecured funds to prepay the first entity's repair service obligation via finance companies or investors.

Referring to block 16, after selecting a first entity, the user of the method 10 selects a second entity for holding predetermined monthly installment payments (typically seventy-two months) made by the owner of the selected equipment in a reserve fund account earmarked to maintain and replace selected equipment owned, leased or otherwise possessed by an individual, partnership or corporation. The second entity is bound by contract with the user of the method to make payments as the user directs, and not to compete against the user. The benefit to the owner to pay periodically is that the owner can budget for future maintenance, repair and replacement of the selected equipment. Further, the owner is afforded the opportunity to replace older equipment sooner than normal with higher efficient equipment which consumes less energy. The funds in the reserve account are ultimately paid to preselected qualified contractors to repair, maintain and replace the selected equipment. The second entity is typically a company that provides financial services or in the business of administering reserve fund accounts for providing maintenance and replacement of the selected equipment, such as Dealer Financial Services (“DFS”), a division of Aqua Finance, Inc., One Corporate Drive, Suite 300, Wausau, Wis., 54401. The second entity ultimately pays periodic interest on the reserve fund accounts to the user of the method 10. Any contract between the user of the method 10 and the second entity will allow the user to terminate the contract, thereby allowing the user to function as the second entity if the user determines that the ultimate monetary return is worth the risk of terminating the relationship with the second entity.

Referring to block 17, the user selects a third entity or contractor for repairing the selected equipment, the first entity and the user of the method must agree as to the selected third entity or contractor. Typically, the third entity is a contracting company or individual having experience servicing equipment and machines similar to the selected equipment. Further, either the user of the method 10 or the first entity, or both are familiar with the work of the selected third entity, thereby providing confidence to the user and first entity that repair, maintenance and replacement services provided by the third entity will be performed in a workmanlike manner. The user of the method and the first entity both posses the right to evaluate the repair, maintenance and replacement work of the third entity, and both possess the right to terminate the third entity, if required. The selected third entity is usually a good source of owners of the selected equipment, thereby providing the user of the method 10 with an expanded potential customer list when the user starts contacting owners pursuant to block 18. Alternatively, the third entity can contact the potential customer and recommend that the customer work with the user of the method 10. Irrespective of the extent of the third entity's list of customers, the user of the method 10 retains the right to limit the quantity of owners of the selected equipment that may do business with any one contractor or third entity.

Referring to block 18, after selecting a third entity, the user of the method 10 may directly or with the assistance of the contractor contact an owner of the selected equipment via phone, advertizing or by customer lists provided by distributors and/or contractors involved with the repair, maintenance and/or replacement of the selected equipment. The incentive for the distributor or contractor to provide the customer lists is that the user of the method 10 may utilize their services instead of their competitors. Further, the distributors or contractors involved with the selected equipment may become members (after paying a membership fee) of a pre-approved group to which the user of the method 10 gives priority, when procuring equipment or services pertaining to the selected equipment. Membership fees would be paid by the distributor or contractor to the user of the method 10 to cover costs to evaluate the would-be member (distributor or contractor). The goal of the user is to ultimately find an owner of the selected equipment, then bind the first entity and the owner to a repair service agreement provided by the first entity.

Referring to block 20, after contacting an owner, the user of the method 10 (with the assistance of the contractor) verify that the owner and the selected equipment satisfy conditions in the repair service obligation or agreement (warranty) provided by the first entity. The conditions in the repair service agreement typically include, but are not limited to allowable repair costs for preselected components of the selected equipment, an allowable time period for repairing the selected equipment, limiting the cancellation options of the owner of the selected equipment, selecting a maximum age and minimum age (greater than the typical one year warranties that cover new equipment) for the selected equipment included in the repair service agreement at the time of execution of the agreement, selecting a minimum time period (72 months) for the installment payments made by the owner of the selected equipment, and providing the first entity with complete discretion when deciding to provide the repair service agreement to the owner of the selected equipment.

If the owner and the selected equipment do not satisfy the conditions in the repair service agreement, the owner and equipment are rejected, and the user of the method 10 returns to block 18 and contacts another owner of the selected equipment. If the owner and the selected equipment satisfy the conditions in the repair service agreement, then the user of the method 10 continues to block 24.

Referring to block 24, after pre-qualifying the owner and the selected equipment, the user of the method 10 then provides a maintenance and replacement services contract to be signed by the owner and third entity, then approved by the user of the method 10, the contract includes, but is not limited to:

requiring the owner of the selected equipment to make predetermined payments to the second entity for a predetermined time period (typically 72 months), a portion of the predetermined payments being held by the second entity for benefit of the third entity irrespective of the third entity performing maintenance and/or replacement services before the termination of the predetermined time period;

requiring the second entity to retain a selected amount of the predetermined payments in a reserve fund for maintenance and replacement of the selected equipment, a predetermined portion (interest) from the reserve fund is periodically paid to the user of the method 10; and

requiring the reserve fund to be insured via a performance bond, the reserve fund ultimately being paid to the third entity for maintaining and replacing the selected equipment.

The maintenance and replacement services contract further includes:

limiting the quantity of annual cleanings and inspections for the selected equipment;

limiting replacements for the selected equipment;

limiting the cancellation options of the owner of the selected equipment;

requiring the maintenance and replacement services contract to be acceptable to the use of the method 10;

limiting the time period for maintaining and replacing the selected equipment;

requiring the owner of the selected equipment to make an initial payment to the second entity;

listing the selected equipment to be covered by the contract;

not refunding any of the predetermined payments in the event that the owner cancels the contract within the first twelve months of executing the contract;

refunding fifty percent of the reserve fund (minus the value of any labor and parts which have been provided to the owner) in the event that the owner cancels the contract after twelve months, provided the owner gives thirty day written notice;

not allowing the owner a cancellation option in the event that selected equipment require replacement prior to the end of the time limitation;

providing the user of the method 10 the option of canceling the contract for cause with no refund to the owner of the selected equipment;

replacing selected equipment not late than the end of the preselected time period;

providing the owner of the equipment the option of replacing the selected equipment with enhanced replacement equipment upon paying a premium to the third entity; and

providing the owner of the equipment the option of prepaying the predetermined payments, thereby allowing the owner to choose the installation date of replacement equipment for the selected equipment within the preselected time period of the contract.

Referring to block 26, after providing a maintenance and replacement services contract, the user of the method 10 determines if the third entity and the owner of the selected equipment both accepted the maintenance and replacement services contract. If either the third entity or the owner did not accept the contract, then the user of the method 10 returns to block 18, whereupon, the user contacts another owner of the selected equipment and proceeds again with the method 10. If the third entity and the owner did accept the contract, then the user of the method 10 proceeds to block 28 and reviews the contract to determine if the contract should be approved. If the final draft of the maintenance, replacement and services contract is acceptable to the user, including all the conditions, terms and provisions in the final draft executed by the third entity and the owner of the selected equipment (block 29), then the contract is accepted via the user signing the contract (block 30). The contract time period then starts to run and the owner of the selected equipment makes a first predetermined payment to the second entity. The owner continues to make the predetermined payments for a predetermined time period.

If the contract is unacceptable, the user does not sign the contract and negotiations between the contractor and that particular owner terminate (block 32). Regardless of the user signing or not signing the contract, if the user of the method 10 wishes to continue searching for owners of the selected equipment (block 34), the user returns to block 18 and contacts another owner of the selected equipment, then proceeds with the method 10. If the user does not want to continue searching for owners, then the method ends (block 36).

A benefit to the first entity of the present method 10 besides the income from warranty sales, is that the contract between the owner and contractor includes maintenance of the selected equipment, thereby lowering the amount of repair work that will be required for the selected equipment. Thus, the first entity will ultimately pay for less repairs to selected equipment covered by warranty between the first entity and owners of selected equipment.

A benefit to the second entity of the present method 10 is that the second entity receives a monthly fee for each reserve fund that the second entity is holding. Further, the second entity is allowed to use up to half the funds in each account for lending purposes, thereby earning as much as fourteen percent (14%) or more on the funds held in each account. The interest paid by the second entity on the funds held is substantially less than fourteen percent.

A benefit to the third entity or contractor is that the contractor, after all parties have signed the contract, receives a relatively small amount of money from the second entity, after the second entity receives the owner's first payment. The contractor gets the small payment without providing any immediate work. Another benefit to the contractor is that the contractor gets paid more than normal for maintenance, repair and replacement of the selected equipment, because the owner budgets for all expenses required for the optimum repair, maintenance and replacement of the selected equipment. Yet another benefit to the contractor is that the contractor is able to forecast sales, build equity, eliminate slow sales periods, avoid laying off employees, and increase purchasing power for the predetermined time period (typically 72 months) that the owner is obligated to make payments.

A benefit to the owner is that the owner is able to budget for all expenses required for any and all repairs, maintenance and replacement of the selected equipment. Another benefit to the owner is that if the selected equipment requires replacement before the end of the preselected time period (the contract time period), the selected equipment will be replaced immediately, thereby allowing the owner to continue making the same relatively small monthly payments until the end of the time period. If the owner did not have the contract with the selected contractor, the owner would be forced to raise a relatively large sum of money quickly, and/or could hire a dishonest contractor to achieve the immediate replacement of equipment not covered by the present method 10.

A benefit to the user of the method 10 is that the user is paid a commission by the first entity for every warranty sold by the first entity to an owner of equipment procured by the user or procured by a contractor selected by the user. Further, the user is paid all the interest on all the reserve account funded via installment payments from owners of the selected equipment that execute maintenance arid replacement contracts with the contractors selected by the user. Also, the user of the method 10 must authorize all contracts between the owners and contractors before the contract becomes binding, thereby protecting the user's interests and preventing owners and contractors from “cutting the user out” of any commissions by working directly with the first entity.

In operation, the method 10 for repairing, maintaining and replacing selected equipment begins by an individual, distributor, contractor or wholesaler (users of the method 10) having experience with equipment (in this scenario, heating, ventilating and air conditioning equipment) requiring repair, maintenance and/or replacement services. The user selects a first entity such as Equiguard, Inc. to provide a warranty or repair contract for the selected equipment for a predetermined time period. The user then selects a second entity such as Dealer Financial Services, Inc. to pay the cost of the warranty, and to hold installment payments from the owner of the selected equipment, the funds ultimately used for maintaining and replacing the selected equipment. The user then selects a third entity (typically a contractor having experience with the selected equipment) for maintaining and replacing the selected equipment. The first entity must agree with the user's selected third party before negotiations with the selected third party may begin. The user then contacts owners of the selected equipment via a myriad of methods to find owners of selected equipment that satisfy conditions in the repair service agreement provided by the first entity. The owners selected equipment must meet predetermined criteria before the owner's equipment qualifies for coverage under the method 10.

The user of the method 10 then provides a maintenance and replacement services contract that will be ultimately executed by the third party and owner of the selected equipment, then signed by the user thereby initiating the terms and conditions of the contract. The maintenance and replacement services contract includes, but is not limited to, requiring the owner of the selected equipment to make predetermined payments to the second entity for a predetermined time period, the payments to be held by the second entity in an insured reserve account that receives interest which is paid to the user. A portion of the reserve account is ultimately paid to the third entity for maintaining and replacing the selected equipment, after the third entity and the owner of the selected equipment both accept the maintenance and replacement services contract provided by the owner.

If the third entity and the owner of the selected equipment sign the maintenance and replacement services contract, the owner of the selected equipment makes the first predetermined payment to the second entity, the second entity pays the first entity to issue a warranty to the owner, and the third entity is paid a relatively small retaining fee (typically $100.00) from owner's first payment, the user of the method 10 is paid a commission from the first entity, and the preselected time period for the repair, maintenance and replacement of the owner's selected equipment is initiated. If the third entity and the owner of the selected equipment do not sign the maintenance and replacement services contract, the user of the method discontinues negotiations with the owner and initiates negotiations with a different owner having the selected equipment.

The foregoing description is for purposes of illustration only and is not intended to limit the scope of protection accorded this invention. The scope of protection is to be measured by the following claims, which should be interpreted as broadly as the inventive contribution permits.

1. A method for repairing, maintaining and replacing selected equipment, said method comprising the steps of:
selecting equipment for repair, maintenance and replacement services;
selecting a first entity for providing a repair service agreement to an owner of said selected equipment, said repair service agreement requiring said first entity to cause the repair of said selected equipment for a predetermined time period;
selecting a second entity for holding funds to maintain and replace said selected equipment;
selecting a third entity for repairing, maintaining and replacing said selected equipment, said first entity and the user of said method for repairing, maintaining and replacing selected equipment must agree to the selection of said third entity;
contacting an owner of said selected equipment, said repair service agreement ultimately binding said first entity and said owner of said selected equipment;
verifying that said owner and said selected equipment satisfy conditions in said repair service agreement provided by said first entity;
selecting a third entity for maintaining and replacing said selected equipment, said first entity and the user of said method for repairing, maintaining and replacing selected equipment must both agree as to the selected third entity; and
providing a maintenance and replacement contract that binds said third entity and said owner of said selected equipment after said user of said method authorizes said contract, said maintenance and replacement contract requiring said owner of said selected equipment to make predetermined payments to said second entity for a predetermined time period, said maintenance and replacement contract requiring said second entity to retain said predetermined payments in a reserve fund for maintenance and replacement of said selected equipment, said reserve fund being insured by a performance bond, said reserve fund ultimately being paid to said third entity for maintaining and replacing said selected equipment.

2. The method of claim 1 wherein the step of selecting a first entity includes the step of selecting a corporation in the business of providing limited warranties covering said selected equipment.

3. The method of claim 1 wherein the step of selecting a second entity includes the step of selecting a corporation in the business of administering reserve funds for providing maintenance and replacement services for said selected equipment of said owner.

4. The method of claim 3 wherein the step of selecting a second entity includes the step of selecting a second entity that pays periodic interest on said reserve fund, said periodic interest being paid to the user of said method for repairing, maintaining and replacing selected equipment.

5. The method of claim 1 wherein the step of selecting a third entity for maintaining and replacing said selected equipment includes the step of evaluating the qualifications of a third entity being considered to provide maintenance and replacement work for said selected equipment.

6. The method of claim 1 wherein the step of contacting an owner of said selected equipment includes the step of utilizing said third entity to contact an owner of said selected equipment.

7. The method of claim 1 wherein the step of providing a repair service agreement includes the steps of:
limiting repair costs for preselected components of said selected equipment;
limiting the time period for repairing said selected equipment;
limiting the cancellation options of said owner of said selected equipment;
selecting a maximum age for said selected equipment included in said repair service agreement; and
providing said first entity with complete discretion when deciding to enter into said repair service agreement with said owner of said selected equipment.

8. The method of claim 1 wherein said step of providing a maintenance and replacement services contract includes the steps of:
limiting the quantity of annual cleanings and inspections for said selected equipment;
limiting replacements for said selected equipment;
limiting the cancellation options of said owner of said selected equipment;
requiring said maintenance and replacement services contract to be acceptable to the user of said method for repairing, maintaining and replacing selected equipment; and
limiting the time period for maintaining and replacing said selected equipment.

9. The method of claim 1 wherein the step of verifying that said owner and said selected equipment satisfy conditions in said repair service agreement include the step of allowing said first entity total discretion when determining said conditions to be satisfied.

10. The method of claim 1 wherein the step of providing a maintenance and replacement services contract includes the step of requiring said owner of said selected equipment to make an initial payment to said second entity after all required signatures to said contract have been procured.

11. The method of claim 1 wherein the step of providing a maintenance and replacement services contract includes the step of listing the selected equipment to be covered by said contract.

12. The method of claim 1 wherein the step of the user prepaying said repair service agreement includes the step of the user prepaying at a discounted price unavailable directly to said owner of said selected equipment.

13. The method of claim 8 wherein the step of limiting said cancellation options of said owner includes the step of not refunding any of said predetermined payments in the event that said owner cancels said contract within the first twelve months of executing said contract.

14. The method of claim 8 wherein the step of limiting said cancellation options of said owner includes the step of refunding fifty percent of said reserve fund (minus the value of any labor and parts which have been provided to said owner) in the event that said owner cancels said contract after twelve months, provided said owner gives thirty days notice.

15. The method of claim 8 wherein the step of limiting said cancellation options of said owner includes the step of not allowing said owner a cancellation option in the event preselected components of said selected equipment require replacement prior to the end of said time limitation.

16. The method of claim 8 wherein the user of said method for repairing, maintaining and replacing selected equipment has the option of canceling said contract for cause with no refund to said owner of said selected equipment.

17. The method of claim 8 wherein said selected equipment will be replaced not later than the end of said time period.

18. The method of claim 8 wherein said owner has the option of replacing said selected equipment with enhanced replacement equipment upon paying a premium to said third entity.

19. The method of claim 8 wherein said owner has the option of prepaying said predetermined payments, thereby allowing said owner to choose the installation date of replacement equipment for said selected equipment within said time period.

20. The method of claim 1 wherein the step of selecting a third entity includes the step of requiring said first entity and a user of said method for repairing, maintaining and replacing selected equipment, to both agree as to the selection of said third entity.

21. The method of claim 1 wherein the step of providing a maintenance and replacement service contract includes the step of paying a portion of said predetermined payments to said third entity for maintenance services.

22. The method of claim 1 wherein the step of selecting a third entity includes the step of limiting the quantity of owners of said selected equipment that may receive services from said third entity.

23. A method for an owner of selected equipment to pay for the repair, maintenance and repair of the selected equipment via predetermined installment payments, said method comprising the steps of:
providing a warranty for the repair of the selected equipment for a predetermined time period;
financing the payment of said warranty;
selecting a contractor for repairing the selected equipment pursuant to said warranty;
contacting an owner of the selected equipment;
verifying that the owner and the selected equipment satisfy preestablished conditions; and
binding the owner and said contractor to a maintenance and replacement contract for the selected equipment, said maintenance and replacement contract requiring predetermined installment payments by the owner of the selected equipment into an account earmarked for maintaining and replacing the selected equipment, said maintenance and replacement contract requiring payments to said contractor for maintaining and replacing the selected equipment, said contractor payments being provided by said account earmarked for maintaining and replacing the selected equipment, said maintenance and replacement contract requiring a predetermined portion of said account to be paid to a user of said method.

24. The method of claim 23 wherein the step of requiring predetermined installment payments into an account includes the step of insuring said account via a performance bond.

25. A method for replacing selected equipment via installment payments, said method comprising the step of:
selecting equipment for repair, maintenance and replacement;
providing a repair warranty to an owner of the selected equipment;
paying the cost of the warranty, a user of said method ultimately receiving a portion of said paid warranty;
repairing the selected equipment when required;
contracting for the maintenance and replacement of the selected equipment, said maintenance and replacement contract being executed by an owner of the selected equipment and a contractor, said contract being authorized by a user of said method; and
paying for the maintenance and replacement of the selected equipment via installment payments from the owner of the selected equipment, said installment payments being held in a reserve account by a finance entity, a predetermined portion of said reserve account being paid to said user of said method, said contractor receiving a predetermined payment from said finance entity after said maintenance and replacement contract is executed by said owner and said contractor and authorized by said user.
